(19) United States
(12) Patent Application Publication
(10) Pub. No.: US 2025/0119983 A1
(43) Pub. Date: Apr. 10, 2025

(54) MASSAGE STONE AND MASSAGE OIL HEATER

(71) Applicant: Jiangsu Sintang Health and Technology Co., Ltd., Yancheng City (CN)

(72) Inventor: Chuankui Du, Yancheng City (CN)

(21) Appl. No.: 18/534,716

(22) Filed: Dec. 11, 2023

(30) Foreign Application Priority Data
Oct. 8, 2023 (CN) 202322696174.3

(51) Int. Cl. H05B 3/06

(52) U.S. Cl. CPC H05B 3/06; H05B 2203/021; H05B 2203/037

(57) ABSTRACT

The utility model provides a massage stone and massage oil heater, and is applicable for the field of massage health care. The heater includes a shell, and further includes a massage oil heating tube, a massage oil heating apparatus, a massage stone heating pot, a massage stone heating apparatus, and a pot lid. Internal dimensions of the massage oil heating tube match an outer contour of a massage oil bottle, and an exterior of the massage oil heating tube is wrapped with the massage oil heating apparatus. The massage stone heating pod is detachably mounted on the massage stone heating apparatus. The heater can heat both massage stones and massage oil bottles, so as to meet the requirements of Spa salon hot stone therapy for heating massage stones and massage oils at a time.

### TECHNICAL FIELD

The utility model belongs to the field of massage health care, in particular to a massage stone and massage oil heater.

### BACKGROUND

Currently on the commercial market, massage oil heaters can heat only massage oils and massage stone heaters can heat only massage stones.

When Spa salons provide customers with hot stone massage, massage stones need to be smeared with massage oils. Therefore, a product that can heat both stones and massage oils is desperately needed on the commercial market. In addition, heating stoves for heating massage stones on the current commercial market generally adopt heating on sides of an inner container of a heating pod, which takes more than 30 minutes for each heating, so electrical energy is wasted, the heating efficiency is low, and the Spa salons have to be kept on at any time every day to cope with sudden visitors.

Therefore, a massage stone heating pod with extremely high heating efficiency is badly needed on the commercial market.

### SUMMARY

An objective of embodiments of the utility model is to provide a massage stone and massage oil heater, aiming to solve the problems that existing heaters have single functions, can heat only massage oils or massage stones, and heat massage stones with low efficiency for a long time.

The utility model is implemented as follows: a massage stone and massage oil heater includes a shell, and further includes:

A massage oil heating tube, a massage oil heating apparatus, a massage stone heating pod, a massage stone heating apparatus, and a pod lid, where

Internal dimensions of the massage oil heating tube match an outer contour of a massage oil bottle, and an exterior of the massage oil heating tube is wrapped with the massage oil heating apparatus;

The massage stone heating kettle is detachably mounted on the massage stone heating apparatus, and the massage stone heating apparatus is arranged at a bottom of the massage stone heating pod; and

The massage oil heating tube, the massage stone heating apparatus, the massage stone heating pod, and the massage stone heating apparatus are all mounted in the shell, and the pod lid is arranged at an upper portion of the massage stone heating pod.

In a further technical solution, the massage oil bottle is movably mounted in the massage oil heating tube.

In a further technical solution, a circuit board is arranged inside the shell, and the circuit board is provided with a pre-stored program.

In a further technical solution, both the massage oil heating apparatus and the massage stone heating apparatus are driven by electric energy.

In a further technical solution, the temperature sensing apparatus is mounted on each of the massage oil heating apparatus and the massage stone heating apparatus, and the temperature sensing apparatus is connected to the circuit board through a wire.

In a further technical solution, there is at least one massage stone heating pod and at least one massage oil heating tube.

In a further technical solution, a temperature adjustment apparatus is arranged on the shell to adjust heating temperatures of the massage oil heating tube and the massage stone heating apparatus.

The massage stone and massage oil heater provided by the embodiments of the utility model can heat both massage stones and massage oil bottles, so as to meet the requirements of Spa salon hot stone therapy for heating massage stones and massage oils at a time. In addition, the heating apparatus for the massage stone heating pod is arranged at the bottom of the heating pod, which can greatly improve the heating efficiency and quickly heat massage stones to reduce electricity consumption.

### BRIEF DESCRIPTION OF THE DRAWINGS

FIG. 1 is a schematic structural diagram of a massage stone and massage oil heater provided by an embodiment of the utility model;

FIG. 2 is a schematic diagram of an internal structure of a massage stone and massage oil heater provided by an embodiment of the utility model, with pod lids in a closed state; and

FIG. 3 is an exploded view of a massage stone and massage oil heater provided by an embodiment of the utility model.

In the figures: shell 1, base 2, upper cover 3, massage oil heating tube 4, massage oil heating apparatus 5, massage stone heating kettle 6, massage stone heating apparatus 7, pod lid 8, circuit board 9, temperature sensing apparatus 10, temperature adjustment knob 11.

### DETAILED DESCRIPTION OF EMBODIMENTS

To make the objectives, technical solutions, and advantages of the utility model clearer, the utility model will be further elaborated below with reference to the accompanying drawings and embodiments. It should be understood that the specific embodiments described here are only intended to explain the utility model, but not to limit the utility model.

The specific implementation of the utility model will be described in detail below in conjunction with the specific embodiments.

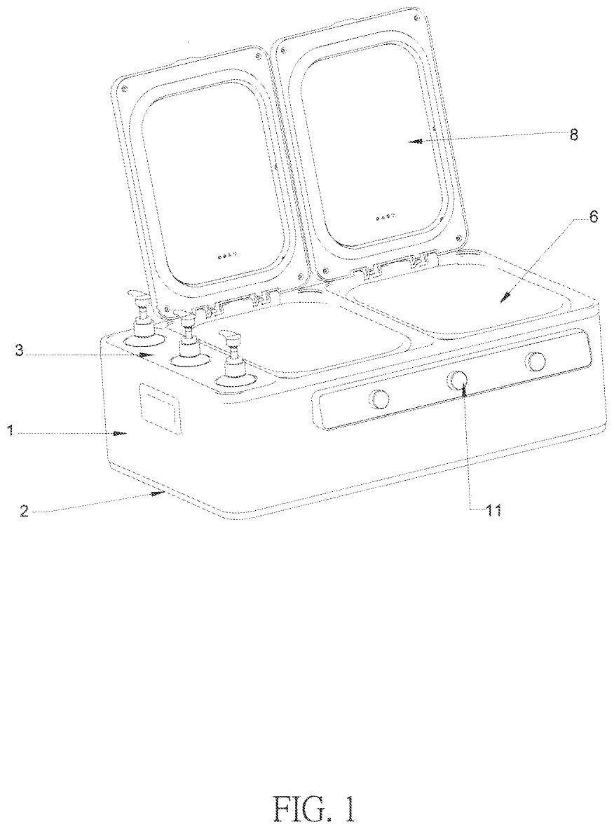

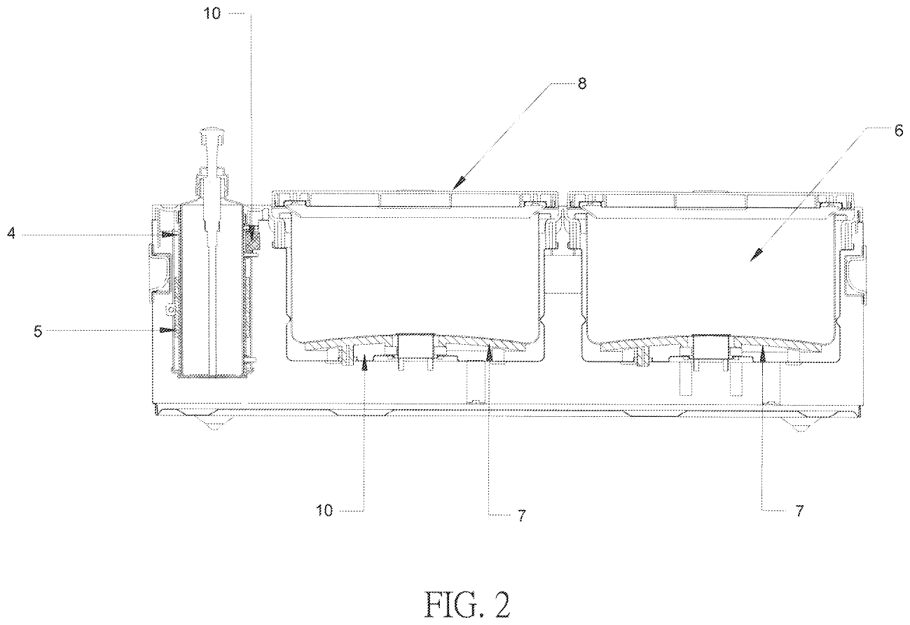

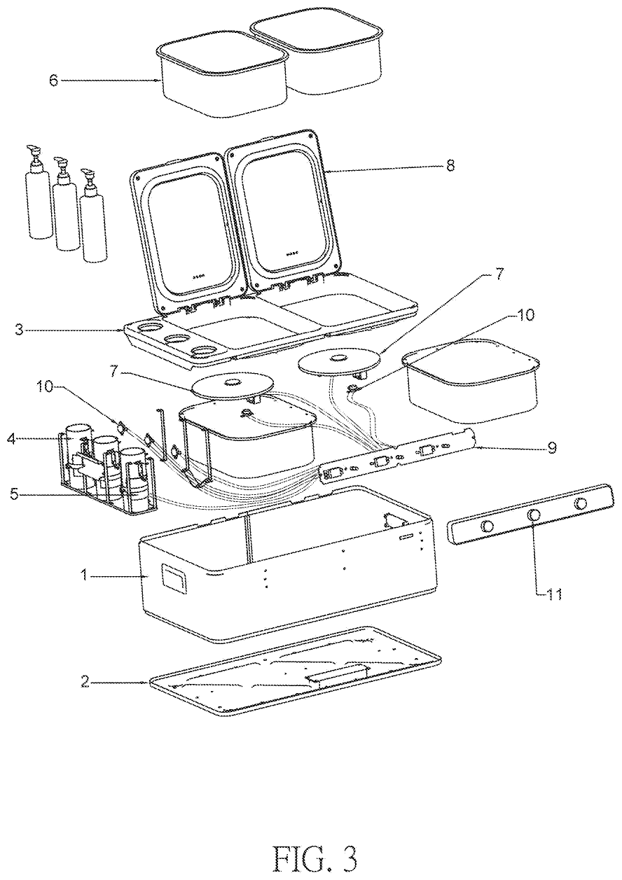

As shown in FIGS. 1-3, a massage stone and massage oil heater provided by an embodiment of the utility model includes a shell 1, a base 2, an upper cover 3, a massage oil heating tube 4, a massage oil heating apparatus 5, a massage stone heating pod 6, a massage stone heating apparatus 7, a pod lid 8, a circuit board 9, a temperature sensing apparatus 10, and a temperature adjustment knob 11.

As shown in FIGS. 1-3, as a preferred embodiment of the utility model, the base 2, the shell 1, and the upper cover 3 are combined together to form a complete device shell. Three massage oil heating tubes 4 are arranged on the upper cover 3. The internal dimensions of the massage oil heating tube 4 is same as an outer contour of a massage oil bottle, the massage oil heating tube 4 is supported by an aluminum tube having a heat conduction function, and an exterior of the massage oil heating tube 4 is wrapped with the massage oil heating apparatus 5.

In the embodiment of the utility model, the massage oil heating tube 4 has a diameter of 52 mm, which is just enough to accommodate the massage oil bottle having a diameter of 50.8 mm (2 inches).

As shown in FIGS. 1-3, as a preferred embodiment of the utility model, the massage stone heating apparatus 7 is mounted in the shell 1, and the massage stone heating apparatus 7 is mounted at an upper portion of the base 2. The massage stone heating pod 6 is movably mounted on the massage stone heating apparatus 7.

As shown in FIGS. 1-3, as a preferred embodiment of the utility model, there are two massage stone heating apparatuses 7 and two massage stone heating pods 6.

As shown in FIGS. 1-3, as a preferred embodiment of the utility model, the massage oil heating tube 4, the massage oil heating apparatus 5, the massage stone heating pod 6, and the massage stone heating apparatus 7 are all mounted in the shell 1, and the pod lid 8 is arranged above the massage stone heating pod 6.

As shown in FIGS. 1-3, as a preferred embodiment of the utility model, the massage stone heating pod 6 is detachably mounted on the massage stone heating apparatus 7, and the massage stone heating apparatus 7 is arranged at a bottom of the massage stone heating pod 6.

In the embodiment of the utility model, the massage stone heating pod 6 is movably mounted on the massage stone heating apparatus 7, so the massage stone heating pod 6 is very convenient to be removed and placed separately, which facilitates a user to inject water and add massage stones therein and to clean it.

As shown in FIGS. 1-3, as a preferred embodiment of the utility model, the massage oil bottle is movably mounted in the massage oil heating tube 4 and can be conveniently removed and placed.

As shown in FIGS. 1-3, as a preferred embodiment of the utility model, the circuit board 9 is mounted in the shell 1, the circuit board 9 is connected to the massage oil heating apparatus 5 and the massage stone heating apparatus 7 through wires, the circuit board 9 is connected to an external power supply to obtain power, the circuit board 9 supplies power to the massage oil heating apparatus 5 and the massage stone heating apparatus 7 through the wires, and the circuit board 9 pre-stores a working program used for controlling the power supplied to the massage oil heating apparatus 5 and the massage stone heating apparatus 7.

In the embodiment of the utility model, both the massage oil heating apparatus 5 and the massage stone heating apparatus 7 are driven by electric energy, and the massage oil heating apparatus 5 and the massage stone heating apparatus 7 can be heated after being powered on.

As shown in FIGS. 1-3, as a preferred embodiment of the utility model, the temperature sensing apparatus 10 is mounted on each of the massage oil heating apparatus 5 and the massage stone heating apparatus 7, and the temperature sensing apparatus 10 is connected to the circuit board 9 through a wire.

In the embodiment of the utility model, when the temperature of a heating unit of any of the three massage oil heating apparatuses 5 and the two massage stone heating apparatuses 7 reaches a preset temperature value, the temperature sensing apparatus 10 prompts the circuit board 9 through the wire by an electrical signal, and the circuit board 9 stops supplying power to the heating unit. When the temperature of the heating unit of any of the three massage oil heating apparatuses 5 and the two massage stone heating apparatuses 7 is lower than the preset temperature value, the temperature sensing apparatus 10 prompts the circuit board 9 through the wire by an electrical signal, and the circuit board 9 continues to supply power to the heating unit.

As shown in FIGS. 1-3, as a preferred embodiment of the utility model, a console is arranged on the shell 1, the console is totally provided with three temperature adjustment knobs 11, the first from left is used for adjusting a set temperature of the massage oil heating apparatuses 5, the second form left is used for adjusting a set temperature of the left massage stone heating apparatus 7, and the first from right is used for adjusting a set temperature of the right massage stone heating apparatus 7.

In the embodiment of the utility model, the user adds water and massage stones into the massage stone heating pods 6, places external massage oil bottles into the massage oil heating tubes 4, and adjusts the set temperature of the massage oil heating tubes 4, the set temperature of the left massage stone heating apparatus 7, and the set temperature of the right massage stone heating apparatus 7 through the three temperature adjustment knobs 11 on the console outside the shell 1. The circuit board 9 supplies power to the massage oil heating apparatuses 5 and the massage stone heating apparatuses 7 according to the pre-stored program. The massage oil heating apparatuses 5 and the massage stone heating apparatuses 7 generate heat after being powered on and heat the massage oil heating tubes 4 and the massage stone heating pods 6, the massage oil heating tubes 4 transfer heat to massage oils inside the massage oil bottles, and the massage stone heating pods 6 heat the water and the massage stones therein.

The foregoing descriptions are merely preferred embodiments of the utility model, and are not intended to limit the utility model. Any modification, equivalent replacement, improvement, and the like made within the spirit and principle of the utility model shall fall within the scope of protection of the utility model.

I claim:

1. A massage stone and massage oil heater, comprising a shell, characterized in that further comprising:
a massage oil heating tube, a massage oil heating apparatus, a massage stone heating pod, a massage stone heating apparatus, and a pod lid,
wherein internal dimensions of the massage oil heating tube match an outer contour of a massage oil bottle, and an exterior of the massage oil heating tube is wrapped with the massage oil heating apparatus;
the massage stone heating pod is detachably mounted on the massage stone heating apparatus, and the massage stone heating apparatus is arranged at a bottom of the massage stone heating pod; and
the massage oil heating tube, the massage stone heating apparatus, the massage stone heating pod, and the massage stone heating apparatus are all mounted in the shell, and the pod lid is arranged at an upper portion of the massage stone heating pod.

2. The massage stone and massage oil heater according to claim 1, characterized in that the massage oil bottle is movably mounted in the massage oil heating tube.

3. The massage stone and massage oil heater according to claim 1, characterized in that a circuit board is arranged inside the shell, and the circuit board is provided with a pre-stored program.

4. The massage stone and massage oil heater according to claim 1, characterized in that both the massage oil heating apparatus and the massage stone heating apparatus are driven by electric energy.

5. The massage stone and massage oil heater according to claim 3, characterized in that the temperature sensing apparatus is mounted on each of the massage oil heating apparatus and the massage stone heating apparatus, and the temperature sensing apparatus is connected to the circuit board through a wire.

6. The massage stone and massage oil heater according to claim 1, characterized in that there is at least one massage stone heating pod and at least one massage oil heating tube.

7. The massage stone and massage oil heater according to claim 1, characterized in that a temperature adjustment apparatus is arranged on the shell to adjust heating temperatures of the massage oil heating tube and the massage stone heating apparatus.
